(19) United States
(12) Patent Application Publication
(10) Pub. No.: US 2007/0152959 A1
(43) Pub. Date: Jul. 5, 2007

(54) Pressure-sensitive button

(75) Inventor: Johan C. Peters, Sankt-Leon Rot (DE)

Correspondence Address: KENYON & KENYON LLP, 1500 K STREET N.W., WASHINGTON, DC, 20005, US

(73) Assignee: SAP AG

(21) Appl. No.: 11/319,435

(22) Filed: Dec. 29, 2005

(51) Int. Cl. G09G 5/00

(52) U.S. Cl. 345/156

(57) ABSTRACT

A pressure-sensitive button on an input device capable of multiple functionality and usable with a computing device. Different applications can vary differences in pressure inputs to represent a size of data selection, different size cursors, applying different ranges of values, different zooms, or different speeds.

### BACKGROUND OF THE INVENTION

Many applications on computing devices have functions that require repetitive movement by the input device. For example, if a user were changing the color of an object in a drawing program, the user would typically have to open a menu that changes the color, pick a color, apply the color and if, the user does not think the color is exactly what he wants, he repeats the process. Similarly, a user traversing a digital map may have to move a mouse back and forth to click on various zoom or directional icons. Or, when selecting cells in a spreadsheet or text in a word processing document, a user would have to drag a box across the objects. Repetitive processes like this waste time, strain users' hands and annoy users. Thus, there is a need for multiple functionality on peripheral devices that can diminish repetitive motions that strain users' hands. This could be done by simply adding more buttons onto a peripheral input device. However, peripheral input devices typically are designed both for functionality and for comfort, for example, having ergonomic housings and buttons placed at the fingertips. There is only a limited amount of space on the surface of most peripheral devices to place new buttons and, consequently, while adding more buttons may provide more functionality, the new buttons would prove unwieldy and uncomfortable to a user. Thus, there is a need in the art for an input device with buttons that have multiple functionality and placed in positions that are still easily accessible to a users' fingertips.

### BRIEF DESCRIPTION OF THE DRAWINGS

FIG. 1 illustrates a system capable of using the input device with a pressure-sensitive button.

FIGS. 2a to 2c illustrate the various functions which may be calculated to determine pressure on a pressure-sensitive button.

FIG. 3 illustrates the logic to run an embodiment utilizing a pressure-sensitive button.

FIGS. 4a to 4e illustrate an example use of a pressure-sensitive button to perform data selection, as shown in a spreadsheet application.

FIGS. 5a to 5e and 6a illustrate an example use of a pressure-sensitive button to apply different ranges of value, as shown in a drawing program.

FIGS. 6b to 6d and 7 illustrate an example use of a pressure-sensitive button in changing the size of a cursor, as shown in a drawing program.

FIGS. 8a to 8b illustrate an example use of a pressure-sensitive button to represent different zooms, as shown in a map program.

FIG. 9 illustrates an example use of a pressure-sensitive button to represent different speeds, as shown on an application with a scroll bar.

FIG. 10 illustrates an input device capable of having a pressure-sensitive button.

### DETAILED DESCRIPTION

Embodiments of the present invention provide an interface device with pressure sensitive buttons which send a signal not only indicating that a button has been pressed but additional information to allow the receiving computing device to determine pressure. Based on the pressure a signal is sent indicating the button depressed and the amount of pressure. A computer system can then utilize this information to perform tasks correlative to the amount of pressure. In one embodiment, differences in pressure inputs represent a size of data selection. In another embodiment, differences in pressure inputs represent different size cursors. In another embodiment, differences in pressure inputs represent applying different ranges of values. In another embodiment, differences in pressure inputs represent different zooms. In another embodiment, differences in pressure inputs represent different speeds. The advantages of these various embodiments is that they decrease the amount of repetitive motions typically required to perform a single function or they may make possible activities which are not possible to perform in another way, such as varying line thickness.

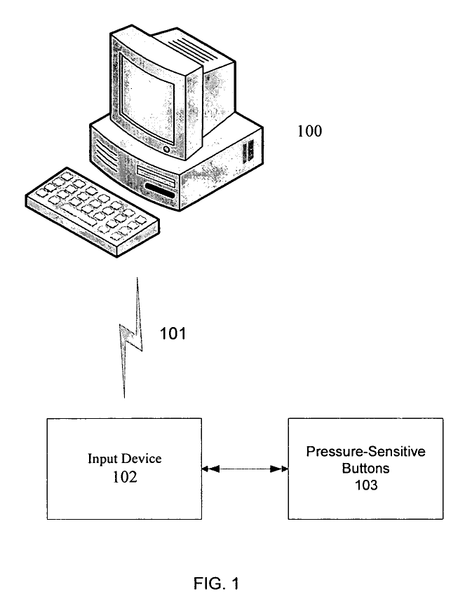

FIG. 1 illustrates a computer system according to an embodiment of the present invention. As illustrated, a computing device 100 represented by a computer is connected to an input device 102 through a communication medium 101. The input device 102 contains pressure-sensitive buttons 103. The input device 102 could be a peripheral device, like that of a mouse, pen, game controller, etc. or it may be directly on the computing device, such as the buttons on a phone, personal digital assistant, handheld game device, etc. The communication medium 101 may be a wired or wireless links, such as those provided by universal serial bus (USB), infrared or Bluetooth links.

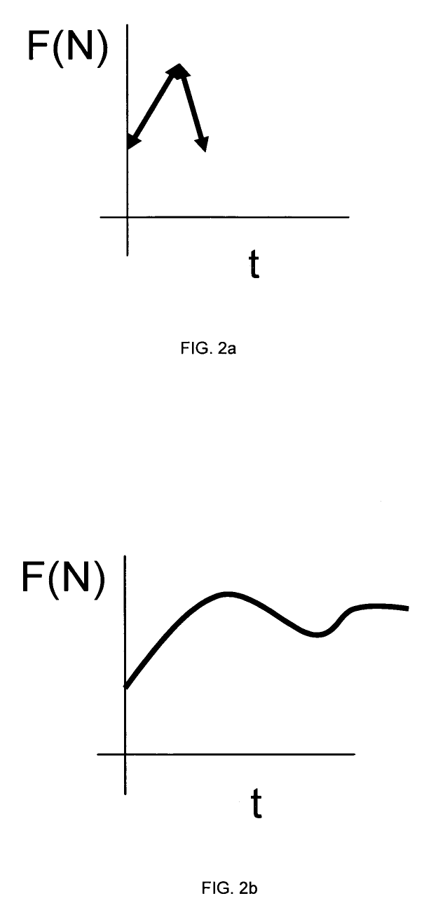

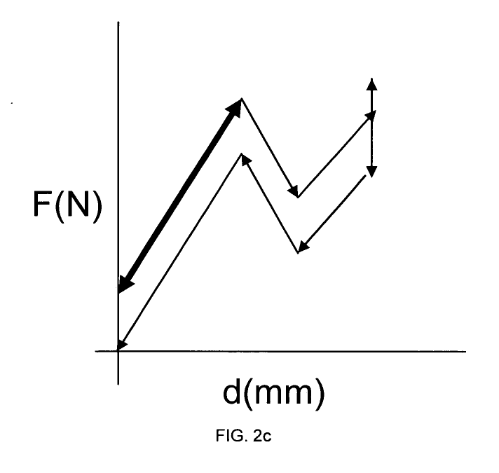

FIGS. 2a and 2b illustrates two different sets of exemplary data that may be captured by a pressure sensitive input device. In FIG. 2a, the input device captures a force delivered over a brief period of time. If the force exceeds a predetermined threshold and returns to a neutral position within a predetermined period of time, the input signal may be interpreted as a “tap” or a “click” of the button. By convention, the click may represent a first command entered into the computer system. On the other hand, when the input device records a force as applied over an extended period of time, (as illustrated in FIG. 2b) the input signal may be interpreted as a pressure-sensitive command. The measured force may then be related to a particular computer function.

FIG. 2c illustrates a calculation of pressure as a function of distance. The number of pressure levels depends on the total range as well as the sensitivity of the button. The relation between force and distance may be the same for increasing and decreasing force.

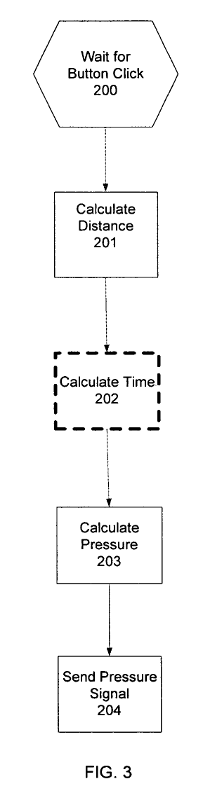

FIG. 3 is a flow chart of a message according to an embodiment of the present invention. Upon the depression of any of the pressure-sensitive buttons 103, the input device 102 may calculate the distance 201, and in some cases also may calculate the time 202 of the depression. Depending on which pressure function is used, the input device may take the distance 201/time 202 information and calculate the amount of pressure applied 203. This pressure information may then be sent 204 through the communication medium 101 and received by the computing device 100. Alternatively, it is possible that the calculation of pressure could also be done on the computing device 100.

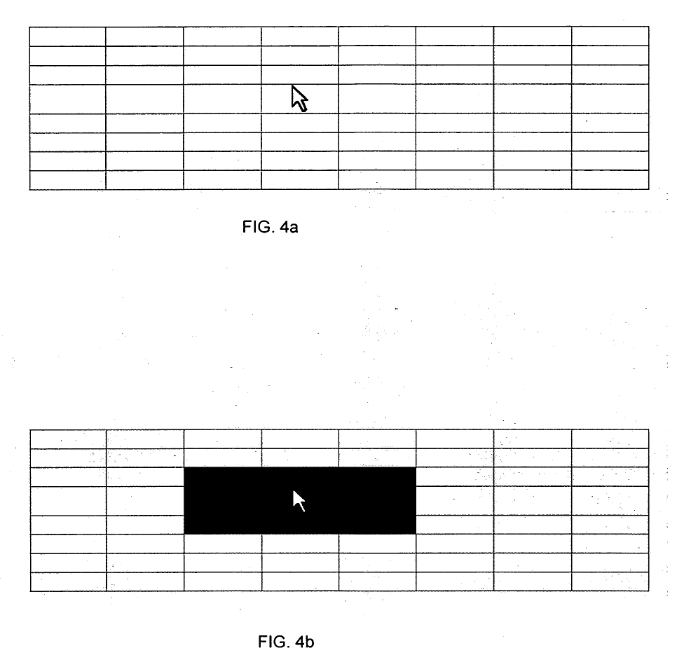

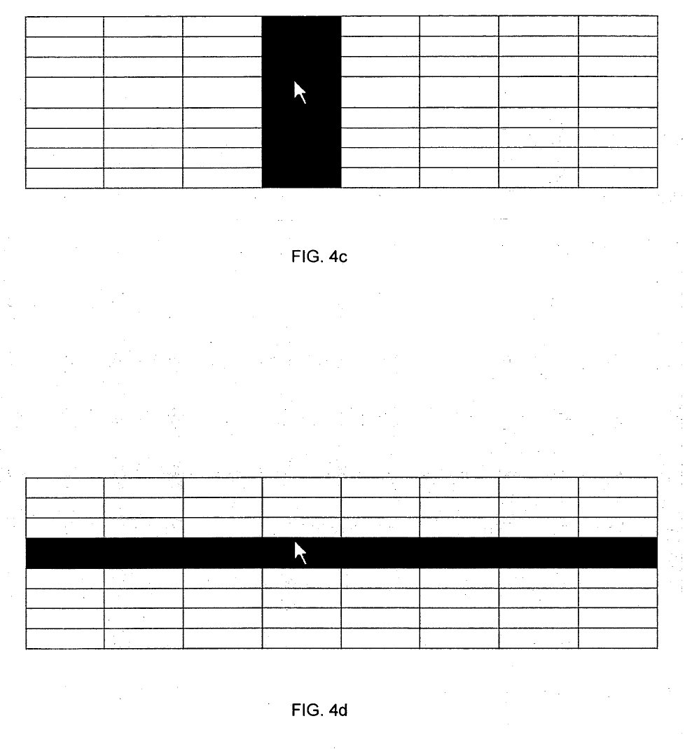

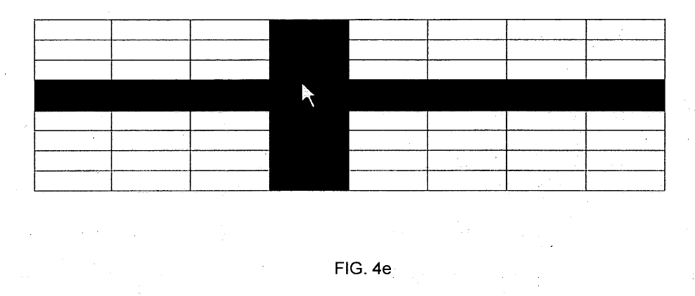

According to an embodiment, a computer system may use detected pressure to vary a size of data selection. FIGS. 4c and 4b illustrate on such example in the context of a spreadsheet application. In the case where the input device 102 is a mouse, it may control the cursor 401 as shown in FIG. 4a. In FIG. 4b, the pressure-sensitive button could be depressed to highlight all the surrounding cells of the initially depressed cells. The application can be adjusted so that the greater the pressure that is applied, a greater number of cells are selected by the operation. As shown in FIG. 4c, the application settings may also be adjusted so that depressing the pressure-sensitive button would highlight all the cells in a column. Alternatively, as shown in FIG. 4d, another application may have the depression of buttons highlight all the cells in a row. FIG. 4e depicts a combination of the two alternatives highlighting both the row and the column under the cursor.

FIGS. 4a to 4e illustrate one example of use of a pressure-sensitive button in data or object selection. These techniques also may find application in other application programs, such as that of a word processing document. For example, in choosing multiple words or paragraphs, a user may be able to click on a single word and slowly expand the selection to encompass other words, sentences, paragraphs, pages, etc. As another example, a pressure-sensitive input may vary selection of icons from within a computer workspace. For example, a user could click on a single icon, and slowly select surrounding icons by varying the pressure on the mouse button. Like that of the spreadsheet cells in the examples in FIGS. 4a to 4c, other applications may also vary the direction in which data selection is performed. Variations on data selection may be performed using compound commands, such as two buttons together to perform a single function or holding a keyboard button while manipulating the pressure on a mouse button. For example, a user could select data vertically using a pressure button, but if another button is pressed (either on a keyboard or another button on a mouse), then the selection of data would occur horizontally.

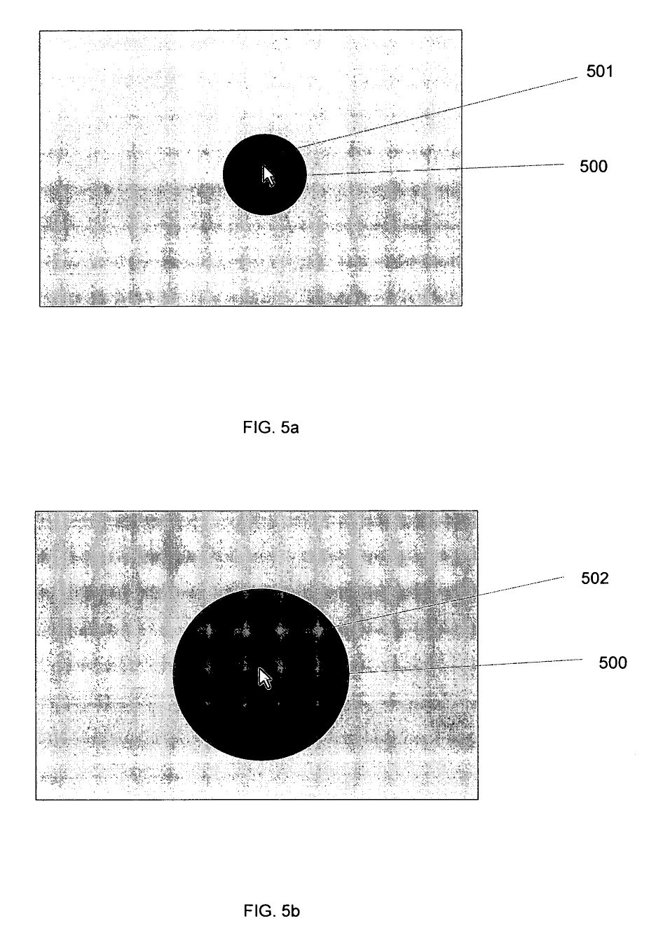

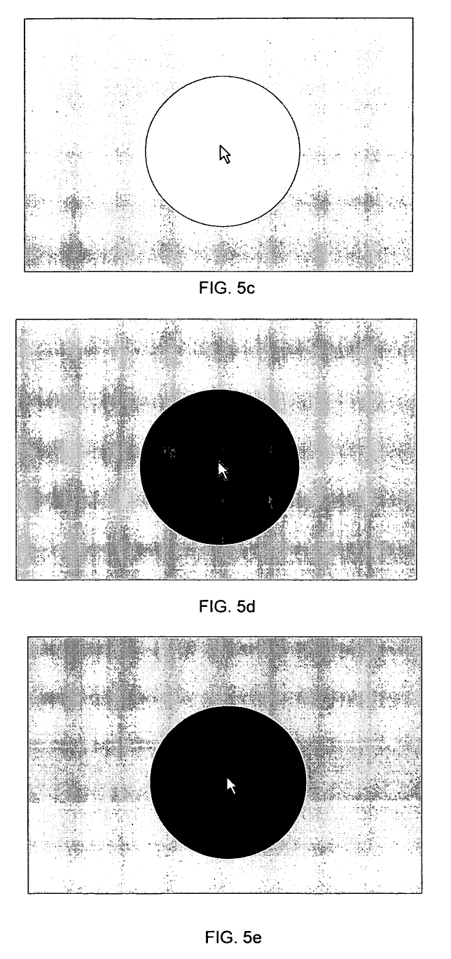

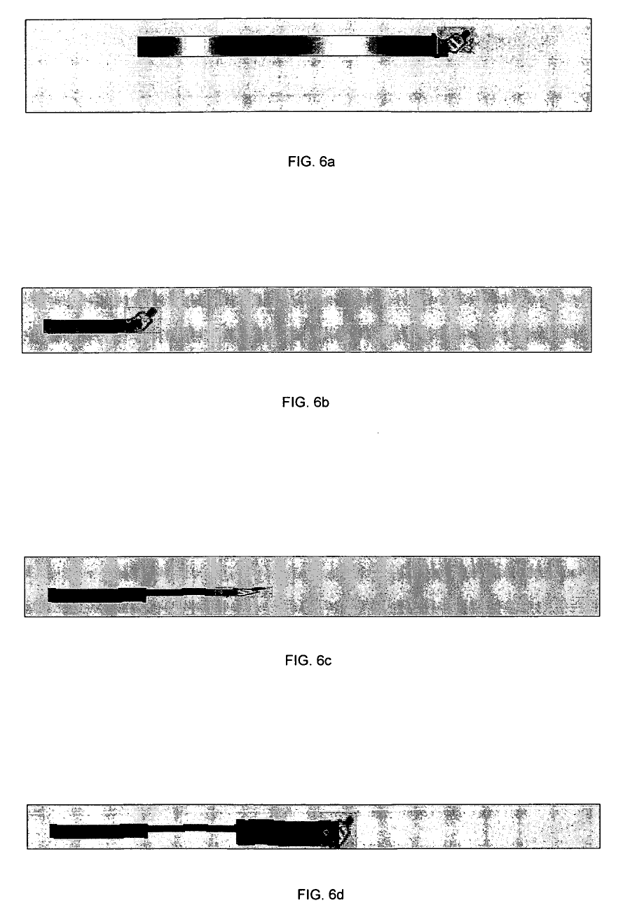

FIGS. 5a to 5e and 6a illustrate one example use of a pressure-sensitive button in applying apply different ranges of value, as shown in the context of a drawing program. In FIG. 5a a cursor 500 is over a drawn circle 501 in a picture program's canvas. As shown in FIG. 5b, by depressing a pressure button, a cursor can increase the size of a circle 502 and by varying the pressure of the button, increasing the size of the circle. An advantage to the embodiment is that the added functionality of the button decreases the amount of unnecessary movements of the input device 102. Further, the added sensitivity of the button allows for more precise manipulation of objects on the screen without undue strain on a user's joints. In addition to size, other ranges of values may be manipulated by a pressure-sensitive mouse. For example, in FIG. 5c a user may want to vary the color of a particular filled shape. Rather than clicking back and forth between a color menu until the appropriate shade is chosen, a user may depress a pressure-sensitive mouse button, which would change either the color or a shade of a color, depending on the setting. Thus, as in FIG. 5c, a color may start off as the lightest shade, and as a pressure-sensitive button is depressed the color may darken as in FIG. 5d and continue to darken until the user releases the button, as shown in FIG. 5e.

FIGS. 6a illustrates another example of the application of a pressure-sensitive button to apply different ranges of value, this time while the mouse is moving. In the sample program, the cursor is in the form of a paint brush. As the button is depressed and the paint brush is dragged along the screen, the user can vary the pressure on the button to increase or decrease the shade of the brush. This is advantageous because in most drawing programs that utilize binary function buttons, a user would have to click back and forth between the color palette and the canvas in order to continuously change the shade. A pressure-sensitive button decreases the unnecessary movements.

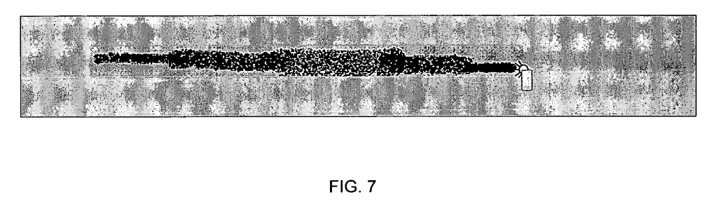

In another embodiment, shown in FIGS. 6b to 6d and 7, the pressure-sensitive button may change the size of a cursor, as for example in a drawing program. For example, an application of the pressure-sensitive button may be to change the thickness of the paint brush. FIG. 6b to FIG. 6d depict the paint brush as it moves across the screen. In FIG. 6b the paint brush is at one thickness that is set when the user depresses the button at medium pressure. As shown in FIG. 6c, as the user depresses the pressure-sensitive button further, the user would see the paint brush tilt on screen, as if he were using the edge of the brush. The thickness would correlate to the tilt and decrease as well. In FIG. 6d, as the user applies the minimum pressure, the paint brush expands to a greater thickness. The advantage of this particular pressure-sensitive functionality, as applied in the example paint program, is that it allows for a more free-flowing brush stroke without the constant interruption of having to change the thickness of the brush. One can appreciate that the thickness to pressure correlation can be adjusted, for example, a user may want greater thickness as more pressure is applied and less thickness as less pressure is applied. Furthermore, if there were two pressure-sensitive buttons, it would be possible to vary both thickness and shade concurrently. In FIG. 7 a variation on the paint brush, a spray paint cursor, may also vary in thickness. In general, any function that would require changing or varying settings, such as color, thickness, size of objects, etc., could be greatly enhanced when used with the pressure-sensitive button.

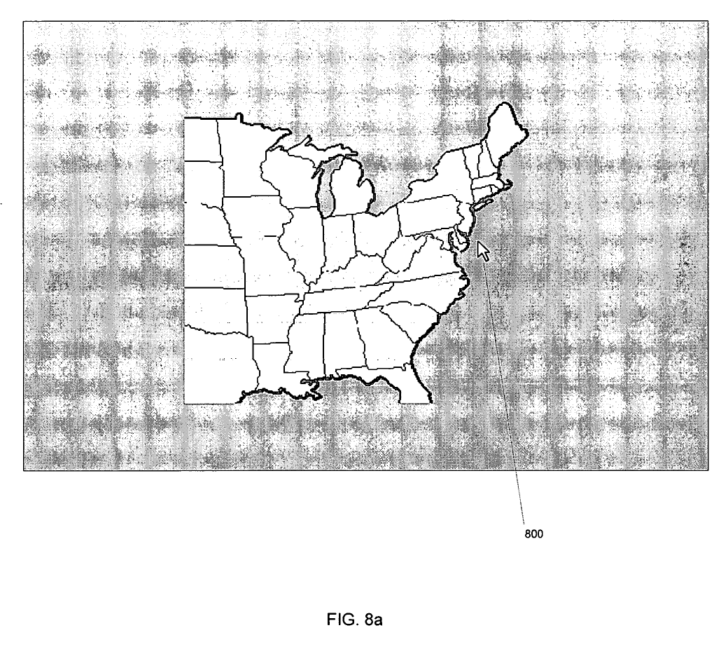

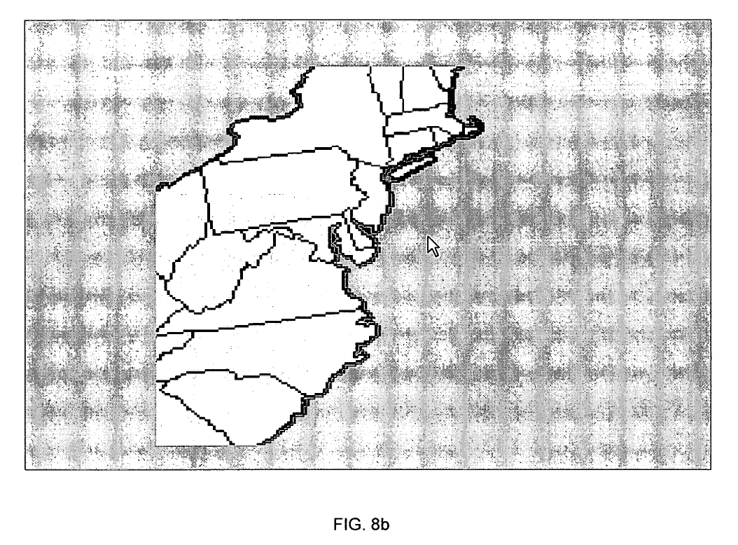

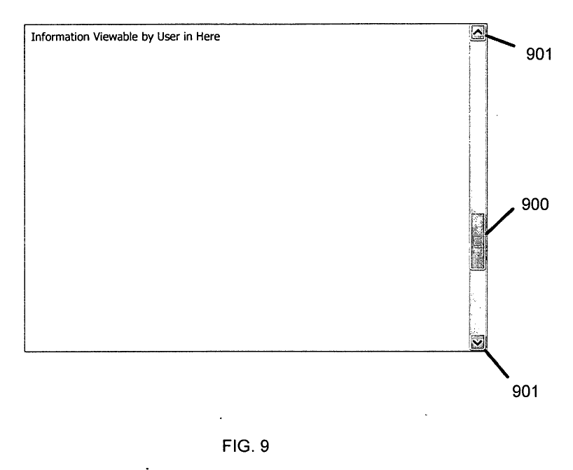

FIGS. 8a and 8b illustrate the use of a pressure-sensitive button to represent different zooms, as for example in a map program. FIG. 8a depicts a cursor 800 hovering over a large view of a map. As shown in FIG. 8b, by using a pressure-sensitive button a user would be able to zoom in and out of a map by depressing the button to zoom in and releasing the button to zoom out. The advantage of this functionality is also to decrease the amount of unnecessary movements of the input device. This is because in most maps in the prior art a user would typically have only 2-dimensional movement using binary button clicks, either horizontal or vertical. The pressure-sensitive button provides an advantage of manipulating both dimensions at the same time because as one button is moving horizontally, the pressure is zooming vertically. This type of functionality may be used in applications to change the view of documents or displays where the user may want to zoom in. For example, other applications, such as word processing documents or image viewers, also have a zoom image. Utilizing a pressure sensitive-button may allow for ease of zooming in an application.

FIG. 9 illustrates an example use of a pressure-sensitive button to represent different speeds, as shown on an application with a scroll bar. In an example application, such as a word processing application, a single document may have more text than is displayable to a viewer. Part of the document would be displayed and a scroll bar 900 may allow a user to move around the screen. Arrows 901 may allow a user to move the scroll bar up and down. Without a pressure-sensitive button the scroll bar moves at a constant speed; however, with a pressure-sensitive button a user may be able to move the scroll bar at varying speeds corresponding to pressure placed on the button. For example, the harder a user presses, the faster the scroll bar may move in a given direction.

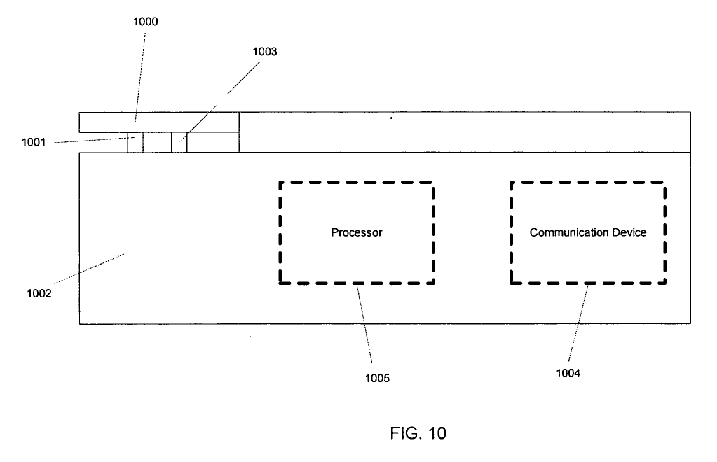

FIG. 10 illustrates an input device 1002 with a housing 1002, a button 1000, and a sensing device 1001. There can also be a flexible material 1003, such as a spring or a rubber insulation, that applies some type of resistance to pressure. The sensing device 1001 could be any sensor that can determine change in distance or pressure, such as a Piezo sensor, a capacitive sensor, a silicon sensor or other known sensors. The number of pressure levels depends on the accuracy of the sensing device 1001 and the pressure range of the flexible material 1003. Each pressure-sensitive button could comprise a grouping of a button 1000, sensing device 1001, and flexible material 1003 with resistive qualities. The input device 102 also contains a processor 1005 that sends the information collected regarding pressure from the button 1000 to the communication device 1004, which could send a wireless signal or simply be connected to a cord. The processor 1005 could either calculate all the information, as is typically done, or it could also format the basic information to be sent to the computing device 100 which would do its own calculation of pressure.

Several embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A navigation method for a computer application, comprising:
determining a position of a cursor within an application window,
selecting a portion of application data located with the position of the cursor in response to user input, wherein an amount of selected data corresponds to an amount of pressure applied via an input device.

2. A method according to claim 1, wherein data selected are cells in a spreadsheet program.

3. A method according to claim 1, wherein data selected are words in a word processing program.

4. A method according to claim 1, wherein data selected are objects in a window.

5. A method for a computer application, comprising:
determining an attribute of an object that can vary within a range of values;
applying a value manipulation operation on an object to vary the value of an attribute corresponding to an amount of pressure applied by a user via an input device.

6. A method according to claim 5, wherein the attribute is size of an object.

7. A method according to claim 5, wherein the attribute is color.

8. A method according to claim 5, wherein the attribute is the shade of a color.

9. A method for a computer application, comprising:
engaging a data manipulation tool of an application,
in response to user interaction with an input device, determining a position of a cursor within an application window,
applying a data manipulation operation on application data, the operating corresponding to the data manipulation tool, wherein the operation is applied using a cursor size corresponding to an amount of pressure applied by a user via the input device.

10. A method according to claim 9, wherein a cursor is a paint brush in a drawing program.

11. A method for a computer application, comprising:
in response to user interaction with an input device, zooming displayed views of data in an application program at a zoom rate corresponding to an amount of pressure applied by a user via the input device.

12. A method according to claim 11, wherein an application program is a map program.

13. A method according to claim 11, wherein an application program is a word processing program.

14. A method according to claim 11, wherein an application program is an image program.

15. A method for a computer application, comprising:
in response to operator interaction with a navigation element of a user interface, scrolling through application data in a direction corresponding to a direction of the navigation element,
wherein the scrolling occurs at a scrolling rate corresponding to an amount of pressure applied via an input device.
